(19) United States
(12) Patent Application Publication
(10) Pub. No.: US 2010/0171883 A1
(43) Pub. Date: Jul. 8, 2010

(54) Data Transmission Over a Video Link

(75) Inventor: Grant Arthur John Elliott, Tai Po (HK)

Correspondence Address: AKA CHAN LLP, 900 LAFAYETTE STREET, SUITE 710, SANTA CLARA, CA, 95050, US

(73) Assignee: ELEMENT LABS, INC., Santa Clara, CA (US)

(21) Appl. No.: 12/484,200

(22) Filed: Jun. 13, 2009

Related U.S. Application Data
(60) Provisional application No. 61/061,338, filed on Jun. 13, 2008.
(60) Provisional application No. 61/061,347, filed on Jun. 13, 2008.
(60) Provisional application No. 61/061,353, filed on Jun. 13, 2008.
(60) Provisional application No. 61/061,358, filed on Jun. 13, 2008.
(60) Provisional application No. 61/061,365, filed on Jun. 13, 2008.
(60) Provisional application No. 61/061,369, filed on Jun. 13, 2008.

(51) Int. Cl. H04N 9/65

(52) U.S. Cl. 348/642; 348/E09.045

(57) ABSTRACT

A technique transfers data over a standard video transport, where this data may be in a nonstandard format or include control, audio, or other nonvideo data, or combinations of these. This standard video transport may be a DVI connection. The technique can increase the color depth by transferring high colors signals in a first packet and low colors signals in a second packet. The low and high color signals are combined to form a received pixel which is shown on a display of the display unit. For example, video with increased color depth and audio signals can be transferred over the standard video transport.

### CROSS-REFERENCE TO RELATED APPLICATIONS

This patent application claims the benefit of U.S. provisional patent applications 61/061,338; 61/061,347; 61/061,353; 61/061,358; 61/061,365; and 61/061,369, all filed Jun. 13, 2008, which are incorporated by reference along with all other references cited in this application.

### BACKGROUND OF THE INVENTION

This invention generally relates to the field of visual displays and particularly to a display unit that includes groups of light emitting elements where a data distribution system is utilized. The invention provides improvements in the design and utilization of such data distribution systems.

Display units for entertainment, architectural, and advertising purposes have commonly been constructed of numbers of light emitting elements such as light emitting diodes (LEDs) or incandescent lamps mounted onto flat tiles. The light emitting elements can be selectively turned on and off to create patterns, graphical and video displays for both informational and aesthetic purposes. These displays may be constructed as tiles or large panels which are assembled in position for a specific entertainment show or event or as an architectural or advertising display.

Displays of these types may be constructed at different resolutions where the spacing between the light emitting elements can be varied. It may also be a desirable to change this spacing at different points on the display.

Many of these systems use large numbers of light emitting elements or pixels acting independently and thus require robust high-speed data distribution systems, often driven by computer derived data or video signals. Further, with the growing acceptance and popularity of digital displays, a new digital interface was needed to display these lighting elements.

An example of an interface is the Digital Video Interface (DVI) which is a standard developed in 1999 by the Digital Display Working Group, a consortium of digital video equipment manufacturers, as a communication means for transporting uncompressed digitally encoded video signals to video displays. DVI is a high-speed serial interface that uses transition minimized differential signaling (TMDS) to send data to a display. The DVI standard encompasses both the electrical and timing standards of the data, which uses TMDS, as well as the cabling and connectors to be used to carry those signals. Use of such standardized distribution systems may be advantageous with reconfigurable displays as the resolution and layout of the pixel data in the data signal can easily be reconfigured to match that of the display.

It may be advantageous to utilize DVI as such use ensures common and inexpensive availability of well constructed cables, connectors, and distribution systems from many different manufacturers. This is particularly important for a display system used for entertainment, architectural and advertising purposes as such displays may commonly be used on many different shows and configurations where the need for simple and easily reconfigurable data distribution is paramount.

DVI is an 8-bit video protocol. DVI is limited to 24 bits per pixel and three-color, RGB, data. Color support is only up to a 24-bit depth, which gives an 8-bit depth to each color. As higher resolution and higher density systems are developed with improved color gamut, it would be advantageous to have a data distribution system that is capable of using the DVI infrastructure and hardware but at greater bit depth and with data for additional colors.

Therefore, there is a need for a technique to provide improved bit depth and color data for a display system while also allowing the continued use of standard DVI cabling and distribution systems.

### BRIEF SUMMARY OF THE INVENTION

A technique transfers data over a standard video transport, where this data may be in a nonstandard format or include control, audio, or other nonvideo data, or combinations of these. This standard video transport may be a DVI connection. The technique can increase the color depth by transferring high colors signals in a first packet and low colors signals in a second packet. The low and high color signals are combined to form a received pixel which is shown on a display of the display unit. For example, video with increased color depth and audio signals can be transferred over the standard video transport.

In a specific implementation, a method of transmitting enhanced pixel display information over a DVI connection to a display includes: transmitting a first packet including first, second, and third high color signals for a pixel over the DVI connection; transmitting a second packet including first, second, and third low color signals for the pixel over the DVI connection; combining the first, second, and third high and low color signals to form a received pixel; and displaying the received pixel on the display.

The first, second, and third high color signals may correspond to the colors red, green, and blue, respectively. Similarly, the first, second, and third low color signals may correspond to the colors red, green, and blue, respectively. Each packet may be 8 bits wide. The pixel may include 48 bits of information.

Furthermore, in an implementation, the DVI connection includes a plurality of data channels. Each of the first, second, and third high color signals may be transmitted on separate data channels. Similarly, each of the first, second, and third low color signals may be transmitted on separate data channels.

In a specific implementation, a method of transmitting enhanced pixel display information over a DVI connection to a display includes: transmitting a first packet including first, second, and third high color signals for a pixel over the DVI connection; transmitting a second packet including first, second, and third low color signals for the pixel over the DVI connection; transmitting a third packet including fourth high and low color signals for the pixel over the DVI connection; combining the first, second, third, and fourth high and low color signals to form a received pixel; and displaying the received pixel on the display.

The first, second, and third high color signals may correspond to the colors red, green, and blue, respectively. Similarly, the first, second, and third low color signals may correspond to the colors red, green, and blue, respectively. The fourth high signal may correspond to the color cyan. Similarly, the fourth low signal may correspond to the color cyan. Each packet may be 8 bits wide. Each pixel may include 64 bits of information.

Furthermore, in a specific implementation, the DVI connection includes a plurality of data channels. Each of the first, second, and third high color signals may be transmitted on separate data channels. Similarly, each of the first, second, and third low color signals may be transmitted on separate data channels.

In an implementation, an apparatus for displaying enhanced pixels transmitted over a DVI connection includes a video controller configured to transmit a pixel including at least four color signals over the DVI connection and a display connected to the video controller over the DVI connection. The apparatus may further include a driver configured to amplify signals over the DVI connection.

In an implementation, a method of transmitting enhanced pixel display information over a DVI connection to a display includes: transmitting a first plurality of packets corresponding to each of a first, second, and third pixel over the DVI connection. Each of the packets includes a first, second, and third high color signal. The method further includes transmitting a second plurality of packets corresponding to each of the first, second, and third pixels over the DVI connection. Each of the packets includes a first, second, and third low color signal. The method further includes transmitting a third plurality of packets including a fourth high color signal and a fourth low color signal corresponding to each of the first, second, and third pixels over the DVI connection. The method further includes combining the each of the color signals from each of the first, second, and third plurality of packets to retrieve the display pixel information for the first, second, and third pixels and displaying the first, second, and third pixels on the display.

In an implementation, an apparatus for displaying high-resolution enhanced pixel display information transmitted over a DVI connection includes a video controller configured to transmit pixel information for a plurality of pixels including four colors over a plurality of DVI connections and a plurality of displays connected to the video controller over the plurality of DVI connections. There can be a plurality of drivers configured to amplify signals over the plurality of DVI connections.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a specific implementation of a system incorporating a technique of the invention.

FIG. 2 shows a panel of a multiple panel display.

FIG. 3 shows a first pixel element implementation.

FIG. 4 shows a second pixel element implementation.

FIG. 5 shows a system of the present invention for performing a technique of the invention.

FIG. 6 shows a simplified system block diagram of a computer system used to execute code for a technique of the invention.

FIG. 7 shows a block diagram of a DVI system where control data and pixel data is sent via the DVI video transport path.

FIG. 8 shows data distribution for a standard DVI system for three colors, each pixel having 8 bits of color data.

FIG. 9 shows a technique of distributing using a standard DVI system four colors, each having 16 bits of color data.

FIG. 10 shows a technique of distributing using a standard DVI system three colors, each having 16 bits of color data.

FIG. 11 shows another technique of distributing using a standard DVI system four colors, each having 32 bits of color data. This data distribution scheme avoids the spare data of FIG. 6.

FIG. 12 shows a technique of achieving high definition resolution display by using multiple DVI signals.

FIG. 13 shows a system of where multiple types of data are transmitted over a standard video data transport.

### DETAILED DESCRIPTION OF THE INVENTION

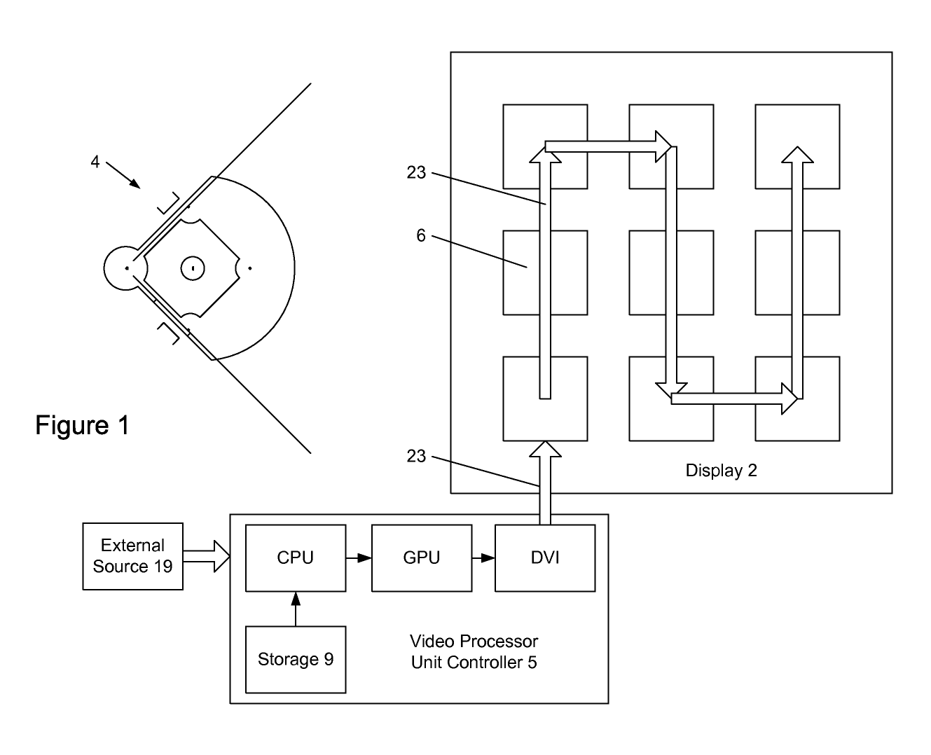

FIG. 1 shows a specific implementation of a system incorporating a technique of the invention. The system has a large video display 2 that is used in such environments as a sports stadium 4 or arena (e.g., baseball, football, basketball, hockey, and soccer), concert venues and theaters, entertainments complexes, retail environments (e.g., shopping malls), outdoor venues and architectural buildings (e.g., billboards, signage, and side of buildings). For example, the display can be placed in the outfield of a baseball stadium to show video of a player at bat, highlights of the play, advertisements, and other video or graphics that provide information (e.g., statistics of the player at bat) or entertain (e.g., show fireworks when a player hits a home run) the fans.

Display 2 is which is made of a number of display panels 6. The figure shows nine display panels arranged in an array of rows and columns. However, the display can have any number of panels, typically more than nine, but depending on the size of a panel, can be fewer than nine panels or even a single panel.

The panels are typically joined together and interlocked to form a single contiguous panel. The panels can be arranged and interlocked in any orientation, such as a rectangular screen in landscape orientation, a rectangular screen in portrait orientation, or a long banner strip. Panels can also be arranged into separate sections, containing gaps (such as with landscaping or fountains between each screen section), and these noncontiguous panels can be controlled simultaneously.

An implementation of a display panel are the Cobra™ display panel products by Element Labs, Inc. The display panel used light emitting diode (LED) technology. Each pixel of the panel has four LEDs of different colors (e.g., red, green, blue, and cyan). Some more details on the Cobra products can be found in U.S. patent application Ser. No. 12/415,627, filed Mar. 31, 2009 and U.S. provisional patent applications 61/072,597, filed Mar. 31, 2008, and 61/170,887, filed Apr. 20, 2009, which are incorporated by reference.

Other display panel technologies which may be used include organic LED (OLED), liquid crystal display (LCD), plasma, digital light processing (DLP), video projection, or cathode ray tube (CRT).

The display is driven by a video processor unit controller 5, which includes a central processing unit (CPU), graphics processing unit (GPU), and Digital Visual Interface (DVI) interface output. A GPU can be connected to any number DVI ports (e.g., one, two, three, four, or five or more). If more DVI ports are needed, more GPUs can be added, each GPU being connected to additional DVI ports. The CPU and GPU process video from a source such as internal storage 9 or external storage 19.

The CPU may be one or more integrated circuit processors manufactured by Intel (e.g., Core™ 2 Duo, Core i7, or Atom), AMD (e.g., Athlon™ or Phenom™ product line), or International Business Machines Corp. (IBM) (e.g., PowerPC product line), or combinations of these.

The GPU may include one or more integrated circuits manufactured by Nvidia Corporation, Advanced Micro Devices (AMD) (e.g., ATI product line), or Intel Corporation (e.g., Intel Graphics Media Accelerator product line), or combinations of these.

In an implementation, video processor unit controller 5 communicates via a display interface such as a DVI output interface (or DVI transmitter) to display 2 and its panels via a DVI interconnection 23. The panels of the display have a DVI input interface or DVI receiver. Other display interface technologies may be used such as HDMI, DFP, DisplayPort, SDI, VGA, and others. However, display interface technologies limit a distance between controller 5 and the display because of interference and noise, which become more significant as the distance increases. Typically a DVI interface can be used for distances of about five meters (about 16 feet). Distances can be greater than five meters depending on the quality of the cabling and strength of the display interface signal transmitters.

Some large displays 2 in large venues such as a stadium may be connected using long length communication channels. When longer distances are needed, a DVI repeater or driver (which amplify the signal) or other longer communication channel technology can be used in conjunction with the DVI connection interface. In particular, the DVI interface can be converted to a fiber optic link or another twisted pair technology (e.g., Ethernet, 802.3 Ethernet over fiber optic cable, or others) by adding interface electronics in the interface path. Alternatively, the controller can be connected using another (nondisplay) interface technology such as Ethernet or USB to the display. Then controller 5 can then be located in a control booth behind and above home plate, while the display is behind center field.

The video source can be stored on internal storage 9, which can be a hard drive or solid state drive (SSD) which can be a video file or other file with instructions on what to display. Video rendering may be performed in real time by the GPU. Software or firmware executing on controller 5 reads the video file and handles performing the operations to display the video on the display. The video may be live video stream, prerecorded video, or text such as scoreboard information.

The video source may also be from external source 19, such as an external hard disk or a computer. Operation of controller 5 may by controlled using a PC and software running on the PC, which tells the controller what to do. A video file residing on the computer may be copied to the internal storage of the controller. Then the video file can be read directly from internal storage instead of from the PC or external source 2.

External source 19 may be implemented using a computer. Video processor unit controller 5 may also be implemented using, or be part of, a computer. For example, video processor unit controller 5 can be considered a specialized computer with a selection of components for video processing. Further, the video processor unit controller can be implemented as one or more plug-in peripheral boards for a computer, or a housed in a separate enclosure, connected to the computer via, for example, a USB connection.

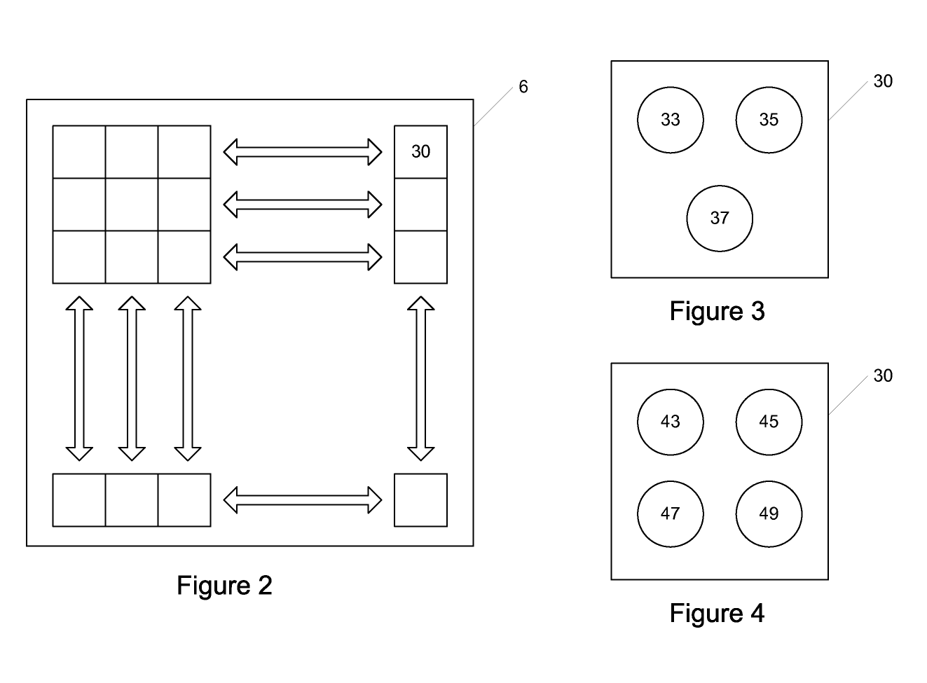

FIG. 2 shows a single panel or tile 6 of a multitiled display 2. Typically each panel in the display is the same as the other panels and the panels are interconnected to form the display. The panel shown has a square shape, but the panel can be any desirable shape such as triangular, rectangular, trapezoidal, hexagonal, or octagonal. In a specific implementation, the panel is 400 millimeters by 400 millimeters in size.

The panel has a number of pixels 30 arranged in an array rows and columns. A panel can have any number of rows and columns of pixels. In a specific implementation, the panel has 24 pixels by 24 pixels per panel. This panel has a pixel density of 3600 pixels per square meter. In another specific implementation, the panel has 36 pixels by 36 pixels per panel. This panel has a pixel density of 8100 pixels per square meter.

FIG. 3 shows a first implementation of a pixel element 30 of a panel. For example, there will be 576 (24*24) or 1296 (36*36) of these pixels in a panel. This pixel element has three LEDs, each of a different color. An LED 33 is red, an LED 35 is green, and an LED 37 is blue. In other implementations, the colors can be a different color set. With its LEDs, the pixel element can display different colors by mixing of the three LED colors. In a specific implementation, the color depth is 16 bits per color.

FIG. 4 shows a second implementation of a pixel element 30 of a panel. Compared to the pixel element of FIG. 3, there is an additional LED of a different color than the other three. This pixel element has four LEDs, each of a different color. An LED 43 is red, an LED 45 is green, an LED 47 is cyan, and an LED 49 is blue. The cyan LED, which is a bluish-green color, has a wavelength of 505 nanometers or 515. In a specific implementation, the color depth is 16 bits per color.

With its LEDs, the pixel element can display different colors by mixing of the four LED colors. The additional pixel element allows the pixel element and consequently the entire display to have an enhanced and greater color gamut than a panel with the three color elements. In other implementations, a pixel element can have more than four LEDs, such as 5, 6, 7, or 8 LEDs per pixel, each a different color than the other pixels.

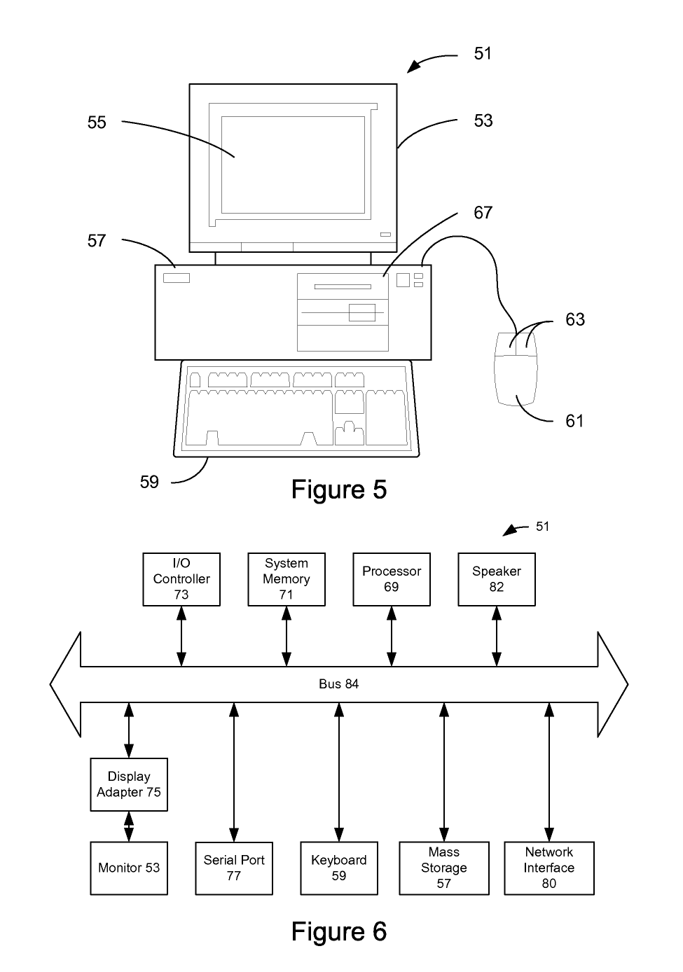

FIG. 5 shows an implementation of a system of the present invention. In an embodiment, the invention is a technique (such as in software or firmware) that executes on an electronic computing or computer system (e.g., standalone computer, client, or server), such as shown in FIG. 5. FIG. 5 shows a computer system 51 that includes a monitor 53, screen 55, enclosure 57, keyboard 59, and mouse or pointing device 61. Mouse 61 may have one or more buttons such as mouse buttons 63. Enclosure 67 (may also be referred to as a system unit, cabinet, or case) houses familiar computer components, some of which are not shown, such as a processor, memory, mass storage devices 67, and the like.

Mass storage devices 67 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), flash and other nonvolatile solid-state storage (e.g., USB flash drive or SSD), battery-backed-up volatile memory, tape storage, reader, and other similar media, and combinations of these.

A computer-implemented or computer-executable version (e.g., a computer program product) of the invention may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 67. The source code of the software of the present invention may also be stored or reside on mass storage device 67 (e.g., hard disk, magnetic disk, tape, or CD-ROM). As a further example, code of the invention may be transmitted via wires, radio waves, or through a network such as the Internet.

FIG. 6 shows a system block diagram of computer system 51 used to execute software of the present invention. As in FIG. 5, computer system 51 includes monitor 53, keyboard 59, and mass storage devices 67. Computer system 51 further includes subsystems such as central processor 69, system memory 71, input/output (I/O) controller 73, display adapter 75 (which can include one or more graphics processing units (GPUs)), serial or universal serial bus (USB) port 77, network interface 80, and speaker 82. The invention may also be used with computer systems with additional or fewer subsystems. For example, a computer system could include more than one processor 69 (i.e., a multiprocessor system) or the system may include a cache memory.

The processor may contain multiple processor cores (e.g., two, three, or four or more) on a single integrated circuit. The system may also be part of a distributed computing environment or grid. In a distributed computing environment, individual computing systems are connected to a network and are available to lend computing resources to another system in the network as needed. The network may be an internal or local Ethernet network (e.g., 10, 100, or 1000 megabits per second Ethernet), Internet, or other network. The system may include one or more graphics processing units, which may reside on the display adapter or be part or another subsystem.

Arrows such as 84 represent the system bus architecture of computer system 51. However, these arrows are illustrative of any interconnection scheme serving to link the subsystems. For example, speaker 82 could be connected to the other subsystems through a port or have an internal connection to central processor 69. Computer system 51 is but an example of a computer system suitable for use with the present invention. Other configurations of subsystems suitable for use with the present invention will be readily apparent to one of ordinary skill in the art.

The system can have one or more display or graphics adapters, each having one or more GPUs. When a system has multiple GPUs, these GPUs can be connected via the system bus. Or the GPUs may be also directly connected together via another separate bus (e.g., Nvidia SLI bus, ATI CrossFire bus, PCI-E bus, or other). These GPUs typically reside on display or graphics adapter 75 and connect to the monitor or display via a display interface such as VGA, DVI, HDMI, or DisplayPort.

The architecture of a GPU can vary depending on the manufacturer. A GPU is generally a massively parallel processor architecture designed for the specific purpose of performing graphics calculations to be displayed on a screen. Many calculations and transformations are used to render three-dimensional graphics and animation in real-time. The GPU accelerates such tasks. However, there are many tasks that a GPU is not designed and cannot handle, such as general processing tasks which is handled by the CPU. Features of a GPU can be incorporated in an application specific integrated circuit (ASIC) or field programmable gate array (FPGA).

Some components of a GPU include shaders, vertex processors, texture processors, fragment processors, z-compare and blend components, texture cache, vertex cache, and shadow buffer. Some shaders include vertext shaders, geometry shaders, and pixel shaders. A shader is a set of software instructions, primarily to calculate rendering effects in the GPU.

Computer software products may be written in any of various suitable programming languages, such as C, C++, C#, Pascal, Fortran, Perl, Matlab (from MathWorks, Inc.), SAS, SPSS, Java, or JavaScript, or any combination of these. The computer software product may be an independent application with data input and data display modules. Alternatively, the computer software products may be classes that may be instantiated as distributed objects. The computer software products may also be component software such as Java Beans (from Sun Microsystems) or Enterprise Java Beans (EJB from Sun Microsystems).

An operating system for the system may be one of the Microsoft Windows® family of operating systems (e.g., Windows 95, 98, Me, Windows NT, Windows 2000, Windows XP, Windows XP x64 Edition, Windows Vista, Windows 7, Windows CE, Windows Mobile), Linux, HP-UX, UNIX, Sun OS, Solaris, Mac OS X, Alpha OS, AIX, IRIX32, or IRIX64, or combinations of these. Microsoft Windows is a trademark of Microsoft Corporation. Other operating systems may be used. A computer in a distributed computing environment may use a different operating system from other computers.

Furthermore, the computer may be connected to a network and may interface to other computers using this network. For example, each computer in the network may perform part of the task of the many series of steps of the invention in parallel. Furthermore, the network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In the discussion below, this patent uses the DVI interface as an example of a specific application and implementation of the principles of the invention. One skilled in the art will recognize that the principles of the invention are applicable to other interfaces including HDMI, DFP, DisplayPort, SDI, and VGA, with any changes as needed, without departing from the scope of the invention.

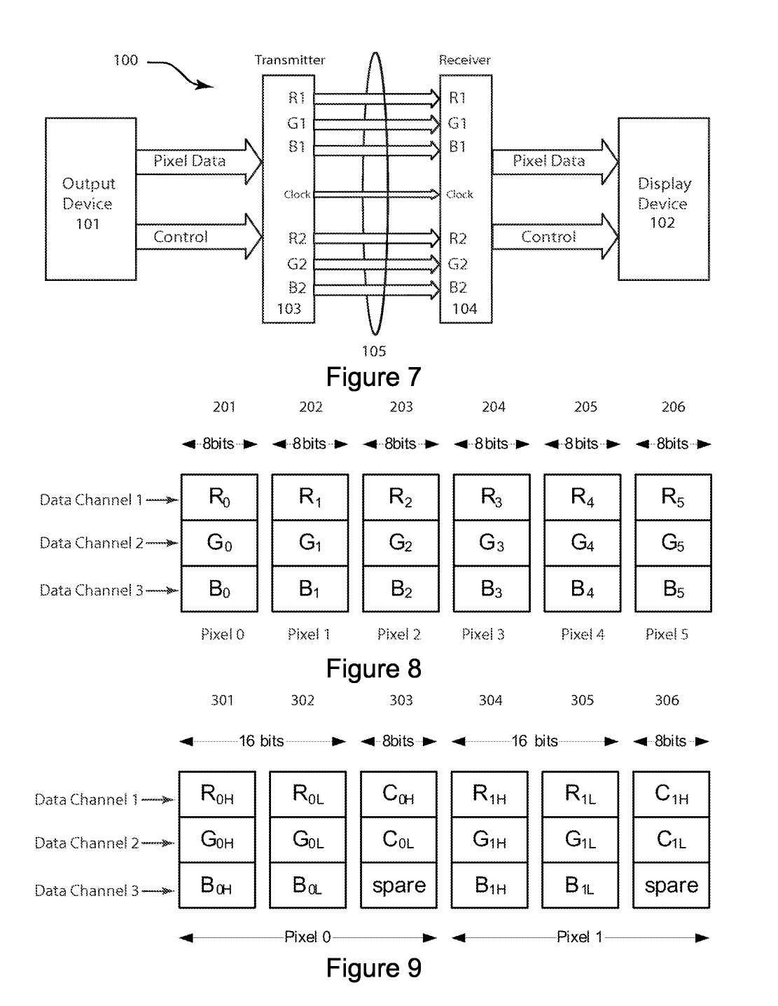

FIG. 7 shows a DVI-connected system 100. An output device 101 sends pixel data and control signals to a transition minimized differential signaling (TMDS) encoder-transmitter 103. Output device 101 may be a controller or computer such as described above. Over a standard DVI connection, only video data is transmitted. But according to a technique of the invention, which is described in detail below, control data and other nonvideo data may also be transmitted over the DVI connection.

The TMDS transmitter outputs a set of signals 105 that is connected (commonly through twisted pair cables) to a TMDS receiver-decoder 104, where the individual pixel data and control signals for both links are received and decoded. TMDS receiver 104 outputs the data in parallel to a display device 102. Display device 102 is a display suitable for displaying pixels using a DVI connection such as one or more display tiles of a large LED video display described above. Other examples are LCD monitors and digital projectors.

More specifically, output device 101 sends 24 bits in parallel, with 8 bits representing each color component, to TMDS transmitter 103. TMDS transmitter 103 receives the 24 bits of parallel data and then encodes and serializes the data before transmitting it. Each of the color components (R, G, and B) and the clock are transmitted on separate links, with a total of four channels. The pixel data for a first video link is TMDS-encoded onto outputs R1, G1, and B1, and pixel data for a second video link may be TMDS-encoded onto outputs R2, G2, and B2. The two links share a common clock signal.

A single DVI connection link includes three data channels and four-twisted cable pairs (red, green, blue, and clock). The link transmits 24 bits per pixel. Those 24 bits are equally divided among the red, green, and blue (R, G, and B) twisted pairs, providing a single 8-bit byte for each color at each pixel. The link has a clock frequency of 165 megahertz (165 million pixels per second) and a bandwidth of up to 3.96 gigabits per second. The DVI link is faster than 100 megabit per second Ethernet and 1 gigabit Ethernet. A single DVI data link Ri, Gi, and Bi may represent a video display of many different resolutions. However a single link is constrained to 24-bit data and three colors, or 8 bits per color.

By including another set of R, G, and B twisted pairs, one DVI connector can have a second data link for a dual-link connection. There are two transmitters and two receivers. With both the first and second data links, the DVI connection has a bandwidth of up to 7.92 gigabits per second, which is twice the bandwidth of a single link. This second data link allows for transmission of another 24 bits per pixel. Therefore, with dual link, 48 bits per pixel can be transmitted.

Dual link can be used when more bandwidth is required than can be transmitted using a single link, such as for high resolution displays. Dual-link can also be used to effectively double the bandwidth and signal quality, such as for use with high resolution displays (e.g., 1920×1600 display resolution).

FIG. 8 shows the data distribution in a standard DVI system. Packets 201-206 illustrate consecutive data sent out on data channel 1 (R), data channel 2 (G), and data channel 3 (B) links of the system. Each data channel is associated with one of the colors. Data channel 1 transmits pixel display information for the red color component (i.e., R₀, R₁, R₂, R₃, R₄, and R₅). Data channel 2 transmits pixel display information for the green color component (i.e., G₀, G₁, G₂, G₃, G₄, and G₅). Data channel 3 transmits pixel display information for the blue color component (i.e., B₀, B₁, B₂, B₃, B₄, and B₅). Packet 201 includes three 8-bit bytes, R₀, G₀, and correspond with pixel 0 of the display. So, pixel 0 includes three sub pixels (R₀, G₀, and B₀). Packet 202 includes bytes R₁, G₁, and B₁ which correspond with pixel 1 of the display, and so on up to packet 206 where R₅, G₅, and B₅ correspond with pixel 5 of the display.

As discussed above, each of the color components (i.e., red, green, and blue) has 8 bits, which allows for 256 different color shades to be selected (2⁸=256) for each color component. Consequently, a combination of the 256 shades for each color component allows up to 16 million colors to be displayed. The pixel display data determines the color of the pixel by the 256 levels set for each R, G, and B pixel.

A technique of the invention utilizes the DVI electrical transmission path and TMDS encoding-decoding. However, the techniques allows for an enhanced DVI link operating at 16 bits per pixel rather than the 8 bits per pixel used by a single standard DVI single link. Additionally, the technique of an enhanced DVI link operates with four colors per pixel, such as, for example, red, green, blue, and cyan, rather than the three colors, red, green, and blue, used by a standard DVI single link. Thus, the number of bits per pixel required for each pixel is 4*16=64 bits, as opposed to the 24 bits used by a single DVI link.

To provide an example, sending 16-bit pixel display information over DVI is discussed in this application. However, the application is not limited to sending 16 bits of pixel display information over DVI. Rather, other interfaces associated with transmitting digital data may be used. For example, in other implementations, 16 bit pixel display information may be sent over high-definition multimedia interface (HDMI), DisplayPort, serial digital interfaces (SDI), or high-definition serial digital interface (HD-SDI).

FIG. 9 shows an embodiment of the present invention showing how modified and enhanced data bit depth and additional color data may be mapped onto a single DVI link data channel. Each of the three data channels, 1, 2, and 3, that represented R, G, and B in a standard DVI link now carries different data in successive packets. Three packets are used to transmit enhanced pixel display data for a single enhanced pixel.

Pixel 0 includes three data packets 301, 302, and 303. Packet 301 contains high byte information for the red, green, and blue color channels in its data channels 1, 2, and 3, respectively. Packet 302 contains the low byte information for the red, green, and blue color channels in its data channels 1, 2, and 3, respectively. Packet 303 contains both the high byte and low byte information for a cyan color channel (an additional color channel), and also has a spare byte in its data channels 1, 2, and 3, respectively. The cyan pixel data can be used to control colors of the cyan LED of a pixel element, such as shown in FIG. 4. This technique can be used for 16-bit color on a display having a four-color pixel element as shown in FIG. 4.

Thus, 16-bits or two-bytes of information may be transmitted for each of the four color channels, red, green, blue, and cyan, resulting in a total of 16 bits×4=64 bits of information, spanning three DVI packets. Similarly, pixel 1 includes three data packets 304, 305, and 306, and so on.

The spare byte can be used for any additional data a user wants to send. No useful bits (e.g., all 0s or all 1s) of data may be sent, which would result in some unused bandwidth in the stream. However, the spare byte can be used to send useful data that may not be video data. For example, this data may be control data, Ethernet data, Internet data, network data, voice data, telephony or voice over IP (VoIP) data, audio data, or any other type of data (other than video data). This additional data would be embedded in the video data stream along with the video data. See FIG. 7 which shows pixel data and control data being sent and received over the same video transport.

In a further implementation, the video transport can be used for transfer data does not include any video data. For example, there may be no video data, and the entire video transport stream is control data, Ethernet data, Internet data, network data, audio data, or other data, and any combination of these.

Although the colors red, green, blue and cyan have been used in this example the patent is not so limited, because the data for any other set of colors may be transmitted using the same methodology. Further, the data for the colors used may be transmitted in any order and the patent is not limited to the color order illustrated.

For example, the color set may be magenta, yellow, blue, and cyan. The low byte may be transmitted before the high byte. Cyan may be transmitted before the high byte or before the low byte. Also any of the channels can be swapped, so data channel 1 is used for green instead of red.

In further embodiments, different numbers of colors may be transmitted to further enhance the gamut of the display, and additional packets of the DVI signal may be utilized to carry the data for those colors.

This figure shows four different colors being transmitted. In other implementations, five, six, seven, eight, nine, or ten or more color signals are transmitted over the DVI signal. Generally, as the number of color signals transmitted increases, the color gamut of the display is enhanced.

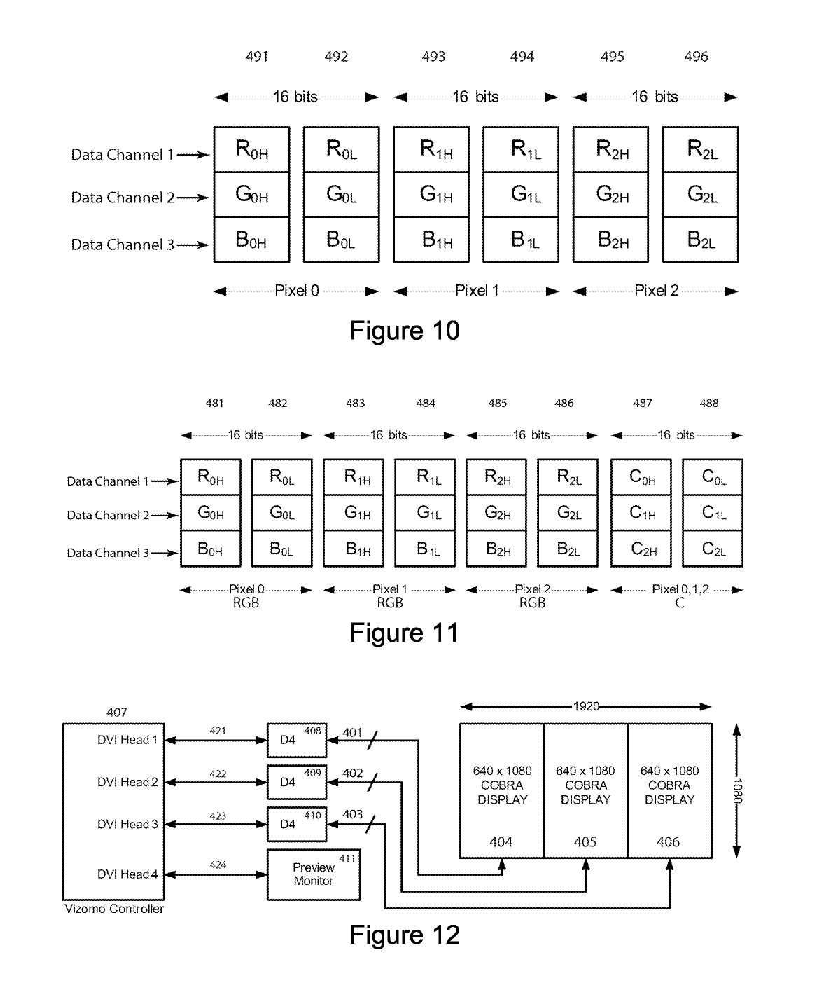

FIG. 10 shows a further implementation how a modified and enhanced data bit depth for a three-color RGB system may be mapped onto a single DVI link data channel. Each of the three data channels, data channels 1, 2, and 3 that represent R, G, and B in a standard DVI link now carries different data in successive packets.

Two data packets may be used to transmit the complete data for a single enhanced pixel. As shown in FIG. 10, pixel 0 includes two data packets 491 and 492. Packet 491 contains the high byte information for the red, green, and blue color channels in its three data channels. And packet 492 contains the low byte information for the red, green, and blue color channels in its three data channels. Thus 16 bit, or two byte, information is transmitted for each of three color channels red, green, and blue spanning two DVI packets. Similarly packets 493 and 494 contain the data for pixel 1; packets 495 and 496 contain the data for pixel 2 and so on. This technique can be used for 16-bit color on a display having a three-color pixel element as shown in FIG. 3.

FIG. 11 shows a further implementation of how modified and enhanced data bit depth and additional color data may be mapped onto a single DVI link data channel. In this implementation the 16 bits, or two bytes, of, information for three enhanced pixels and four color channels, red, green, blue, and cyan, are carried in eight data packets. The high and low byte information for the RGB signals for the three pixels are carried by 6 data packets 481-486 in the same manner as described above and illustrated in FIG. 10. The enhanced color information for the cyan (C) signal is then transmitted in two further data packets 487 and 488 where packet 487 may carry the high byte cyan information for three pixels and packet 488 may carry the low byte cyan information for the same three pixels.

The cyan information associated with pixels 0, 1, and 2 is transmitted together in 2 data packets 487 and 488. This data transmission is similar to that in FIG. 9 because the same number of colors a color depth is being transmitted. However, this organization avoids the spare packets slots where potentially no useful data is being transmitted. This technique can be used for 16-bit color on a display having a four-color pixel element as shown in FIG. 4.

Although a bit depth of 16 bits per color has been used in these examples, the invention is not so limited and other bit depths may be used in further embodiments. Using the technique of the invention, any desirable bit depth can be selected. For example, if three data packets are used per color, then the bit depth will be 24 bits per colors. When four data packets are used, then the bit depth will be 32 bits per color. Also the bit depth does not need to be a factor of 8 (i.e., n packets *8), but can be any desirable bit depth. If the bit depth is not a factor of 8, there is a possibility of the bit fields will be spare, similar to the situation in FIG. 9. However, through organizing how and the order in which the data is transmitted, one can maximize bandwidth to minimize the amount of spares or unused bits fields, such as the situation in FIG. 11.

Additionally, it is not necessary for the bit depth to be the same for each color, and yet further embodiments of the invention may use differing bit depths for different colors. For example, one of the colors, such as cyan, can have 16 bits while the RGB have 24 bits.

Finally, although the data bytes are illustrated in this application as being sent high byte first the invention is not so limited, and the data bytes may be sent in any order.

Referring again to FIG. 9, because the data for each enhanced pixel in the system disclosed consumes three data packets of the DVI signal the maximum pixel rate of the disclosed embedded data format (and hence the effective pixels per DVI output) are reduced by a factor of three from that of standard DVI. The present invention is not limited to a factor of three, because alternative embodiments may result in a different reduction factor. This reduction factor, and the inherent limitation to data rate enforced by the DVI specification, restricts the enhanced DVI system to lower screen resolutions (in this embodiment only one third of the total pixels of a standard DVI link may be transmitted in a single enhanced DVI link). And thus, higher screen resolutions such as the standard High Definition (HD) 1920×1080 pixels may not be possible with a single disclosed enhanced DVI link. To regain the pixel resolution and allow full HD signals to be displayed, a single display may be divided into multiple segments and use multiple links, one per segment as illustrated in FIG. 12.

Referring now to FIG. 12, a video controller 407 (such as the Vizomo™ video processor product by Element Labs) may output three DVI signals 421, 422, and 423. Each of these DVI outputs are encoded using the new enhanced encoding and contain the data for a 640×1080 pixel display where each pixel has four colors (red, green, blue, and cyan) with a 16-bit per color pixel bit depth.

Each of these three enhanced DVI signals 421, 422, and 423 is connected to associated drive electronics 408, 409 and 410 which, in turn connect through distribution cables 401, 402 and 403 to appropriate display segment 404, 405 and 406. Thus display segment 404 receives the data from DVI output 1 through enhanced DVI signal 421, display segment 405 receives the data from DVI output 2 through enhanced DVI signal 422 and display segment 406 receives the data from DVI output 3 through enhanced DVI signal 423. The complete display comprises the three segments 404, 405 and 406 and thus has a total resolution of 640+640+640=1920×1080 pixels.

Although a reduction factor of three and a corresponding use of three segments is disclosed in this implementation is not so limited and any reduction factor and corresponding number of segments may be used in other embodiments. For example the implementation in FIG. 11 sends the data for three enhanced pixels over eight data packets of the DVI signal thus producing a reduction factor of 8/3, which is less than 3. Thus, by avoiding the spare data bytes shown in FIG. 9, this implementation offers a more efficient encoding system.

FIG. 12 also shows the use of a further DVI output 424 to drive a preview monitor 411. Signal 424 is standard 8 bit, three-color (RGB) DVI and drives a standard monitor 411.

Embodiments disclosed in this application may provide for one or more of the following advantages. First, the enhanced data distribution system disclosed herein may allow additional color information that is not supported by the DVI specification to be transmitted over a standard DVI connection. The enhanced data distribution system disclosed herein may also allow for an increased bit depth of information to be transmitted over a standard DVI connection. Embodiments disclosed herein may also allow for high-resolution displays to utilize additional color information transmitted over multiple standard DVI connections.

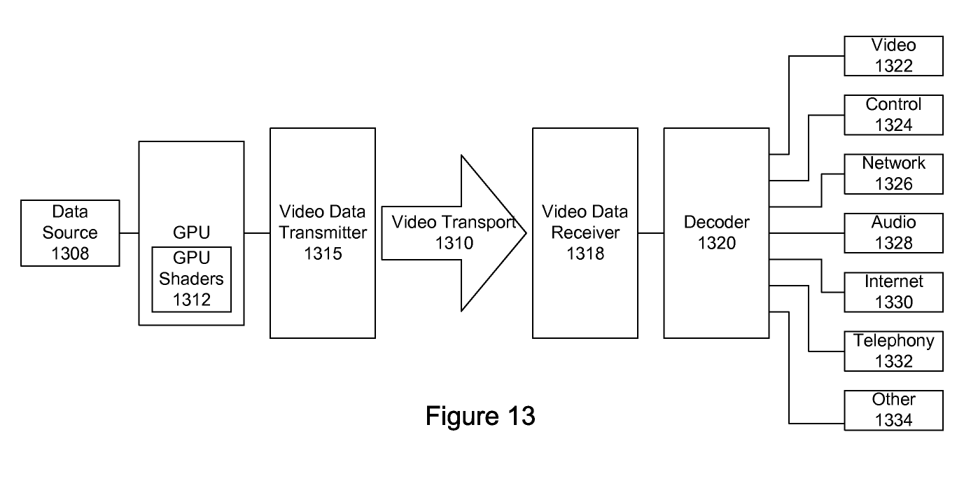

FIG. 13 shows a block diagram of a system where multiple types of data are transmitted from a data source 1308 over a video data transport 1310 such as a DVI connection. The type of data transmitted from data source 1308 can include video, but is not necessarily limited to video data. For example, as discussed above, the data can include control data and other types of data.

GPUs and video transports are not designed to transmit data other than video data. So, software (e.g., GPU shaders 1312), is used to control the GPU to transmit the data which may include nonvideo data. The GPU shaders also control how the data is transmitted via the video data transmitter 1315. For example, running GPU shaders can increase the color depth as shown in FIGS. 9-11 and described above.

A video data receiver 1318 receives the information from the video data transmitter. Since this data is not necessarily video data, there is a decoder 1320 to recover and assemble the information sent. This decoder can be a multiplexer or switch, or the decoder function may be implemented in software or firmware. The decoder takes video data 1322 from the transmitted stream (1310) and directs it to the display (such as a panel 6 of display 2 of FIG. 1). The decoder can recover other types of data including control 1324, network 1326, audio 1328, Internet 1330, telephony 1332, and other data 1334, in any combination.

Video transport 1310 (e.g., DVI or another video protocol) can be used to send any one of these types of data by itself or any combination with the other types of data. For example, in various implementations, the video transport is used to send only control data; no video data is sent at all. The video transport is used to send only Ethernet data; no video data or other data is sent at all. When a combination of types of data is sent over the video transport, the data is multiplexed together.

The control data may be used to control for example, fans, air conditioning, or dimming of the lights in a theater. The audio data may be a soundtrack for the video being displayed. When the video transport is used for both video and sound for a movie, this is no need to run audio cables. An HDMI connect transmits both video and audio, but the audio is transmitted on dedicated audio pins; HDMI does not transmit audio over the video lines. Therefore, the technique of the invention also minimizes the number of pins needed in the interface; two additional lines for audio are not needed. This reduces the cost of the connector and cable.

Video transport 1310 is generally a unidirectional transport. If a bidirectional transport is desirable, however, a similar configuration as shown can be implemented in the opposite direction. So, there will be two video transports, one in each direction.

When using the GPU to perform computations, using the video transport as the transport mechanism allows quick and efficient transmission of data. There is no need to run additional cabling. Also, there is added complexity to copy data to a network driver, CPU, or other output card. This added complexity is avoided by using the video transport. Further, the video transport often has a higher bandwidth than other transmission means (e.g., Ethernet or USB).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A method of transmitting enhanced pixel display information over an interface connection to a display comprising:
transmitting a first packet comprising first, second, and third high color signals for a pixel over the interface connection;
transmitting a second packet comprising first, second, and third low color signals for the pixel over the interface connection;
combining the first, second, and third high and low color signals to form a received pixel; and
displaying the received pixel on the display.

2. The method of claim 1 wherein the first, second, and third high color signals correspond to the colors red, green, and blue, respectively.

3. The method of claim 1 wherein the first, second, and third low color signals correspond to the colors red, green, and blue, respectively.

4. The method of claim 1 wherein each packet is 8 bits wide.

5. The method of claim 1 wherein the pixel comprises 48 bits of information.

6. The method of claim 1 wherein the interface connection comprises a plurality of data channels.

7. The method of claim 6 wherein each of the first, second, and third high color signals are transmitted on separate data channels.

8. The method of claim 6, wherein each of the first, second, and third low color signals are transmitted on separate data channels.

9. A method of transmitting enhanced pixel display information over a DVI-standard connection to a display comprising:
transmitting a first packet comprising first, second, and third high color signals for a pixel over the DVI connection;
transmitting a second packet comprising first, second, and third low color signals for the pixel over the DVI connection;
transmitting a third packet comprising fourth high and low color signals for the pixel over the DVI connection;
combining the first, second, third, and fourth high and low color signals to form a received pixel; and
displaying the received pixel on the display.

10. The method of claim 9 wherein the first, second, and third high color signals correspond to the colors red, green, and blue, respectively.

11. The method of claim 9 wherein the fourth high signal corresponds to the color cyan.

12. The method of claim 9 wherein the first, second, and third low color signals correspond to the colors red, green, and blue, respectively.

13. The method of claim 9 wherein the fourth low signal corresponds to the color cyan.

14. The method of claim 9 wherein each packet is 8 bits wide.

15. The method of claim 9 wherein each pixel comprises 64 bits of information.

16. The method of claim 9 wherein the DVI connection comprises a plurality of data channels.

17. The method of claim 16 wherein each of the first, second, and third high color signals are transmitted on separate data channels.

18. The method of claim 16 wherein each of the first, second, and third low color signals are transmitted on separate data channels.

19. An apparatus for displaying enhanced pixels transmitted over a DVI connection comprising:
a video controller configured to transmit a pixel comprising at least four color signals over the DVI connection; and
a display connected to the video controller over the DVI connection, wherein a pixel element of the display comprises four different color LEDs.

20. The apparatus of claim 19 wherein one of the four different color LEDs is cyan colored having a wavelength of 505 nanometers.

21. The apparatus of claim 19 wherein one of the four different color LEDs is cyan colored having a wavelength of 515 nanometers.

22. The apparatus of claim 19 further comprising a driver configured to amplify signals over the DVI connection.

23. A method of transmitting enhanced pixel display information over a DVI connection to a display comprising:
transmitting a first plurality of packets corresponding to each of a first, second, and third pixel over the DVI connection, wherein each of the packets comprises a first, second, and third high color signal;
transmitting a second plurality of packets corresponding to each of the first, second, and third pixels over the DVI connection, wherein each of the packets comprises a first, second, and third low color signal;
transmitting a third plurality of packets comprising a fourth high color signal and a fourth low color signal corresponding to each of the first, second, and third pixels over the DVI connection;
combining the each of the color signals from each of the first, second, and third plurality of packets to retrieve the display pixel information for the first, second, and third pixels; and
displaying the first, second, and third pixels on the display.

24. An apparatus for displaying high-resolution enhanced pixel display information transmitted over a DVI connection comprising:
a video controller configured to transmit pixel information for a plurality of pixels comprising four colors over a plurality of DVI connections; and
a plurality of displays connected to the video controller over the plurality of DVI connections.

25. The apparatus of claim 24 further comprising a plurality of drivers configured to amplify signals over the plurality of DVI connections.
